(19) United States
(12) Patent Application Publication
(10) Pub. No.: US 2025/0038894 A1
(43) Pub. Date: Jan. 30, 2025

(54) PERFORMING A PHYSICAL UPLINK SHARED CHANNEL TRANSMISSION BASED ON A CONFIGURED GRANT IGNORING RRC CONFIGURED HARQ STATES

(71) Applicant: Lenovo (Singapore) Pte. Ltd., New Tech Park (SG)

(72) Inventors: Joachim Löhr, Wiesbaden (DE); Hyung-Nam Choi, Ottobrunn (DE); Prateek Basu Mallick, Dreieich (DE)

(21) Appl. No.: 18/697,085

(22) PCT Filed: Sep. 14, 2022
(86) PCT No.: PCT/IB2022/058675

§ 371 Date: Mar. 29, 2024

Related U.S. Application Data
(60) Provisional application No. 63/250,043, filed on Sep. 29, 2021.

(51) Int. Cl. H04L 1/1822; H04W 72/21; H04W 76/28

(52) U.S. Cl. CPC H04L 1/1822; H04W 72/21; H04W 76/28

(57) ABSTRACT

Apparatuses, methods, and systems are disclosed for performing a physical uplink shared channel transmission based on a configured grant. One method includes receiving, at a user equipment, a HARQ state configuration for a set of HARQ processes over RRC signaling. The method includes receiving a CG for a PUSCH transmission. The method includes performing a PUSCH transmission based on the CG for a HARQ process associated with the CG without considering at least part of the HARQ state configuration for the HARQ process.

### CROSS-REFERENCE TO RELATED APPLICATIONS

This application claims priority to U.S. Patent Application Ser. No. 63/250,043 entitled “APPARATUSES, METHODS, AND SYSTEMS FOR UPLINK HARQ PROTOCOL OPERATION FOR NON-TERRESTRIAL NETWORKS” and filed on Sep. 29, 2021 for Joachim Lohr et al., which is incorporated herein by reference in its entirety.

### FIELD

The subject matter disclosed herein relates generally to wireless communications and more particularly relates to performing a physical uplink shared channel (“PUSCH”) transmission based on a configured grant (“CG”).

### BACKGROUND

In certain wireless communications systems, there may be different hybrid automatic repeat request (“HARQ”) state configurations. The different HARQ state configurations may be used at different times.

### BRIEF SUMMARY

Methods for performing a physical uplink shared channel transmission based on a configured grant are disclosed. Apparatuses and systems also perform the functions of the methods. One embodiment of a method includes receiving, at a user equipment (“UE”), a HARQ state configuration for a set of HARQ processes over radio resource control (“RRC”) signaling. In some embodiments, the method includes receiving a CG for a PUSCH transmission. In certain embodiments, the method includes performing a PUSCH transmission based on the CG for a HARQ process associated with the CG without considering at least part of the HARQ state configuration for the HARQ process.

One apparatus for performing a physical uplink shared channel transmission based on a configured grant includes a receiver to: receive a HARQ state configuration for a set of HARQ processes over RRC signaling; and receive a CG for a PUSCH transmission. In some embodiments, the apparatus includes a transmitter to perform a PUSCH transmission based on the CG for a HARQ process associated with the CG without considering at least part of the HARQ state configuration for the HARQ process.

Another embodiment of a method for performing a physical uplink shared channel transmission based on a configured grant includes transmitting, at a network device, a HARQ state configuration for a set of HARQ processes over RRC signaling. In some embodiments, the method includes transmitting a CG for a PUSCH transmission. In certain embodiments, the method includes receiving a PUSCH transmission based on the CG for a HARQ process associated with the CG without at least part of the HARQ state configuration for the HARQ process being considered.

Another apparatus for performing a physical uplink shared channel transmission based on a configured grant includes a transmitter to: transmit a HARQ state configuration for a set of HARQ processes over RRC signaling; and transmit a CG for a PUSCH transmission. In some embodiments, the apparatus includes a receiver to receive a PUSCH transmission based on the CG for a HARQ process associated with the CG without at least part of the HARQ state configuration for the HARQ process being considered.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing a physical uplink shared channel transmission based on a configured grant;

FIG. 2 is a schematic block diagram illustrating one embodiment of an apparatus that may be used for performing a physical uplink shared channel transmission based on a configured grant;

FIG. 3 is a schematic block diagram illustrating one embodiment of an apparatus that may be used for performing a physical uplink shared channel transmission based on a configured grant;

FIG. 4 is a schematic block diagram illustrating one embodiment of communications in a system in which there is a large timing advance (“TA”) in a non-terrestrial network (“NTN”) that results in a large offset in a UE's downlink (“DL”) and uplink (“UL”) frame timing;

FIG. 5 is a schematic block diagram illustrating one embodiment of communications in a system in which there is a TA in a NTN that results in a large offset in a gNB's DL and UL frame timing;

FIGS. 6A and 6B are schematic block diagrams illustrating embodiments of communication in systems;

FIG. 7 is a schematic block diagram illustrating another embodiment of communication in a system;

FIG. 8 is a schematic block diagram illustrating one embodiment of communications corresponding to CG configurations;

FIG. 9 is a diagram illustrating one embodiment of a configured grant information element (“IE”);

FIG. 10 is a flow chart diagram illustrating one embodiment of a method for performing a physical uplink shared channel transmission based on a configured grant; and

FIG. 11 is a flow chart diagram illustrating another embodiment of a method for performing a physical uplink shared channel transmission based on a configured grant.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

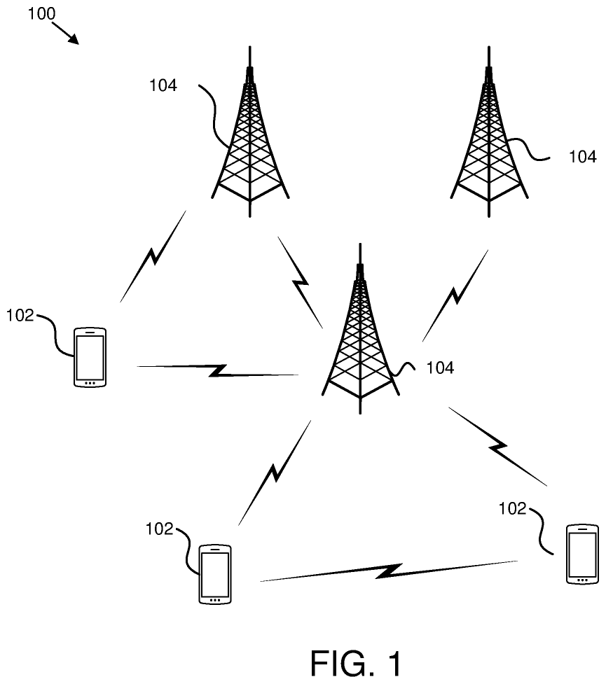

FIG. 1 depicts an embodiment of a wireless communication system 100 for performing a physical uplink shared channel transmission based on a configured grant. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the DL and the remote units 102 transmit on the UL using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a HARQ state configuration for a set of HARQ processes over RRC signaling. In some embodiments, the remote unit 102 may receive a CG for a PUSCH transmission. In certain embodiments, the remote unit 102 may perform a PUSCH transmission based on the CG for a HARQ process associated with the CG without considering at least part of the HARQ state configuration for the HARQ process. Accordingly, the remote unit 102 may be used for performing a physical uplink shared channel transmission based on a configured grant.

In certain embodiments, a network unit 104 may transmit a HARQ state configuration for a set of HARQ processes over RRC signaling. In some embodiments, the network unit 104 may transmit a CG for a PUSCH transmission. In certain embodiments, the network unit 104 may receive a PUSCH transmission based on the CG for a HARQ process associated with the CG without at least part of the HARQ state configuration for the HARQ process being considered. Accordingly, the network unit 104 may be used for performing a physical uplink shared channel transmission based on a configured grant.

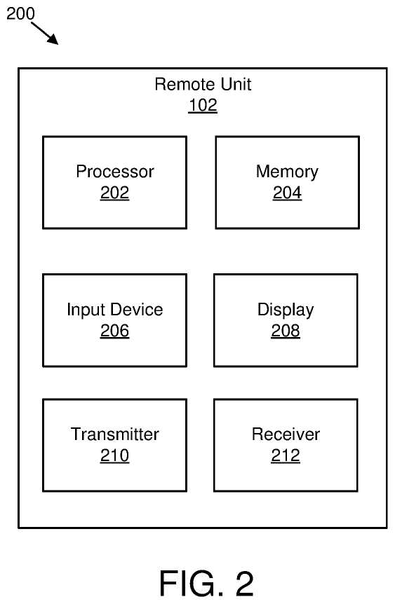

FIG. 2 depicts one embodiment of an apparatus 200 that may be used for performing a physical uplink shared channel transmission based on a configured grant. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to: receive a HARQ state configuration for a set of HARQ processes over RRC signaling; and receive a CG for a PUSCH transmission. In some embodiments, the transmitter 210 to perform a PUSCH transmission based on the CG for a HARQ process associated with the CG without considering at least part of the HARQ state configuration for the HARQ process.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

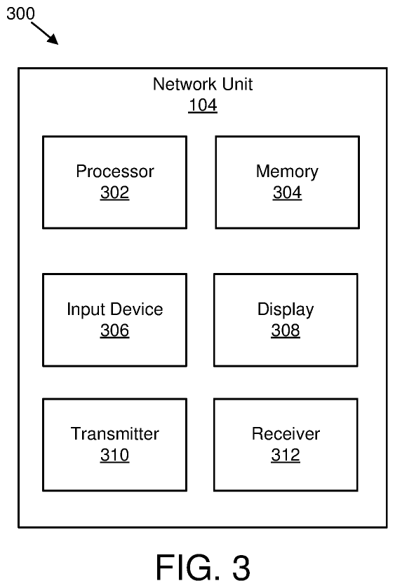

FIG. 3 depicts one embodiment of an apparatus 300 that may be used for performing a physical uplink shared channel transmission based on a configured grant. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 to: transmit a HARQ state configuration for a set of HARQ processes over RRC signaling; and transmit a CG for a PUSCH transmission. In some embodiments, the receiver 312 to receive a PUSCH transmission based on the CG for a HARQ process associated with the CG without at least part of the HARQ state configuration for the HARQ process being considered.

It should be noted that one or more embodiments described herein may be combined into a single embodiment.

In certain embodiments, new radio (“NR”) may support NTNs.

NTNs may refer to networks or segments of networks that use an airborne or spaceborne vehicle for transmission, such as: 1) spaceborne vehicles: satellites (e.g., including low earth orbiting (“LEO”) satellites, medium earth orbiting (“MEO”) satellites, geostationary earth orbiting (“GEO”) satellites as well as highly elliptical orbiting (“HEO”) satellites); and 2) airborne vehicles: high altitude platforms (“HAPs”) encompassing unmanned aircraft systems (“UAS”) including lighter than air UAS (“LTA”), heavier than air UAS (“HTA”), all operating in altitudes typically between 8 and 50 km, quasi-stationary.

In some embodiments, there may be enhancements identified for NR NTN especially LEO and GEO with implicit compatibility to support high altitude platform station (“HAPS”) and air to ground (“ATG”) scenarios according to the following principles: 1) frequency division duplexing (“FDD”) is assumed—this does not imply that time division duplexing (“TDD”) cannot be used for relevant scenarios such as HAPS and/or ATG; 2) Earth fixed tracking area is assumed with Earth fixed and moving cells; and 3) UEs have global navigation satellite systems (“GNSS”) capabilities.

In various embodiments, enhancements to NR radio interface and NG RAN may include enhancing features to address the issues such as long propagation delays, large Doppler effects, and moving cells in NTN, such as: 1) timing relationship enhancements; 2) enhancements on UL time and frequency synchronization; and/or 3) HARQ (e.g., number of HARQ processes, enabling and/or disabling of HARQ feedback).

In certain embodiments, there may be enhancement on a physical random access channel (“PRACH”) sequence and/or format and extension of the random access response window duration (e.g., for a UE with GNSS capability but without pre-compensation of timing and frequency offset capabilities). In some embodiments, there may be enhancements to a feeder link switch and/or beam management and bandwidth parts (“BWP”) operation for NTN with frequency reuse (e.g., including signaling of a polarization mode). In various embodiments, offset based solutions for timer adaptations may be assumed.

In some embodiments, the following user plane procedures enhancements may be specified: 1) medium access control (“MAC”): a) random access (e.g., including a definition of an offset for the start of the random access response window (e.g., ra-ResponseWindow) for NTN, introduction of an offset for the start of the ra-ContentionResolutionTimer to resolve random access contention, solutions for resolving preamble ambiguity and extension of random access response (“RAR”) window, adaptation for Msg-3 scheduling—only for the case with pre-compensation of timing and frequency offset at UE side), b) enhancement of UL scheduling to reduce scheduling latency, c) discontinuous reception (“DRX”) (if HARQ feedback is enabled, introduction of offset for drx-HARQ-round-trip delay (“RTT”)-Timer DL and drx-HARQ-RTT-TimerUL and if HARQ is turned off per HARQ process, adaptions may be made in the HARQ procedure), c) scheduling request: extension of the value range of sr-ProhibitTimer; 2) radio link control (“RLC”): a) status reporting: extension of the value range oft-Reassembly, and b) sequence numbers: extension of the sequence number (“SN”) space only for GEO scenarios; and/or 3) packet data convergence protocol (“PDCP”): a) service data unit (“SDU”) discard: extension of the value range of discardTimer, and b) sequence numbers: extension of the SN space for GEO scenarios.

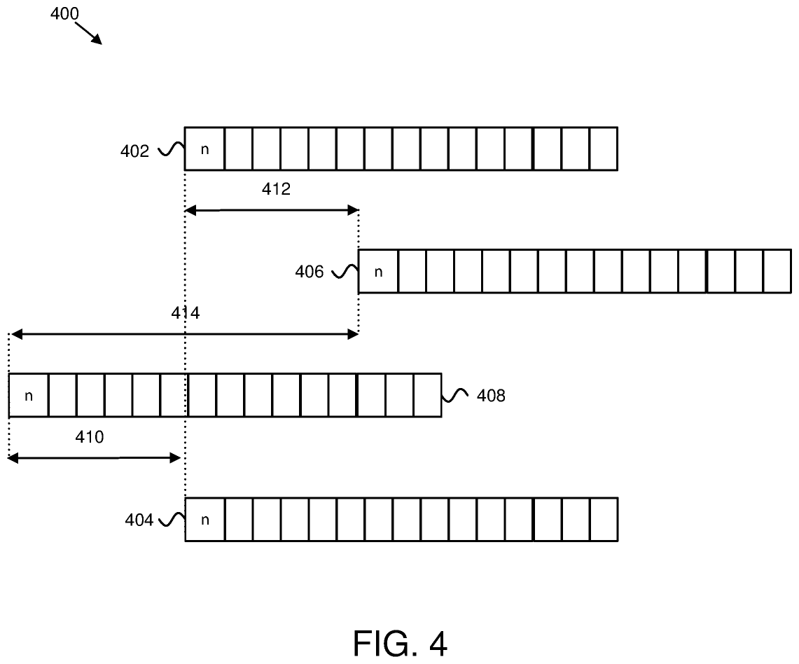

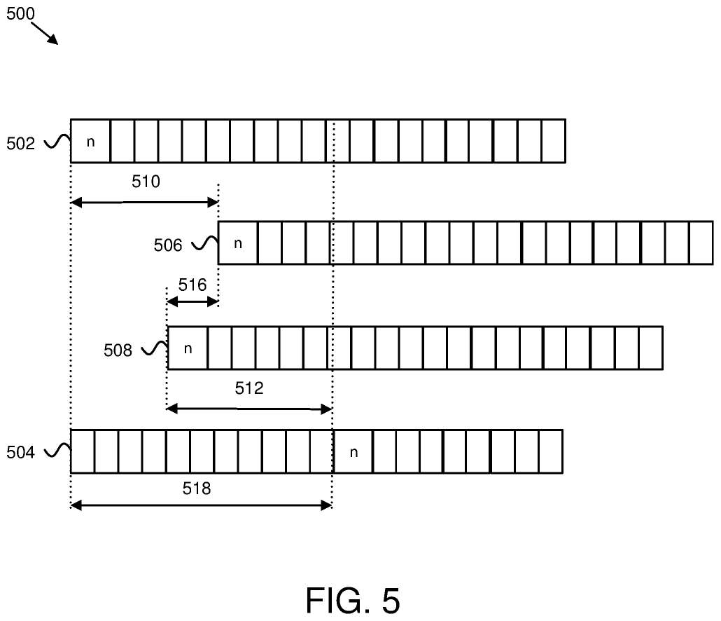

In various embodiments, such as in an NTN, a UE may need to apply a large TA value that leads to a large offset in its DL and UL frame timing. FIG. 4 illustrates a scenario where the UE applies a large TA and gNB's DL and UL frame timing are aligned. An embodiment in FIG. 5 does not need the alignment between gNB's DL and UL frame, where the UE applies a UE specific differential TA and a common TA offset in the gNB's DL and UL frame timing exists. However, for the solution illustrated in FIG. 5, additional complexity is needed at the network side to manage a corresponding scheduling timing. Various NR physical layer timing relationships may need to be enhanced to cope with the large offset in the UE's DL and UL frame timing.

FIG. 4 is a schematic block diagram illustrating one embodiment of communications 400 in a system in which there is a large TA in a NTN that results in a large offset in a UE's DL and UL frame timing. The communications 400 include a gNB DL message 402, a gNB UL message 404, a UE DL message 406, and a UE UL message 408. A first delay 410 between the start of the UE UL message 408 and the start of the gNB UL message 404 is illustrated, and a second delay 412 between the start of the gNB DL message 402 and the start of the UE DL message 406 is illustrated. Further, a TA 414 is shown between the start of the UE UL message 408 and the start of the UE DL message 406.

FIG. 5 is a schematic block diagram illustrating one embodiment of communications 500 in a system in which there is a TA in a NTN that results in a large offset in a gNB's DL and UL frame timing. The communications 500 include a gNB DL message 502, a gNB UL message 504, a UE DL message 506, and a UE UL message 508. A first delay 510 between the start of the gNB DL message 502 and the start of the UE DL message 506 is illustrated, and a second delay 512 between the start of the UE UL message 508 and an offset of the gNB UL message 504 is illustrated. Further, a TA 516 is shown between the start of the UE UL message 508 and the start of the UE DL message 506. An offset 518 illustrates a gNB DL to UL frame timing shift.

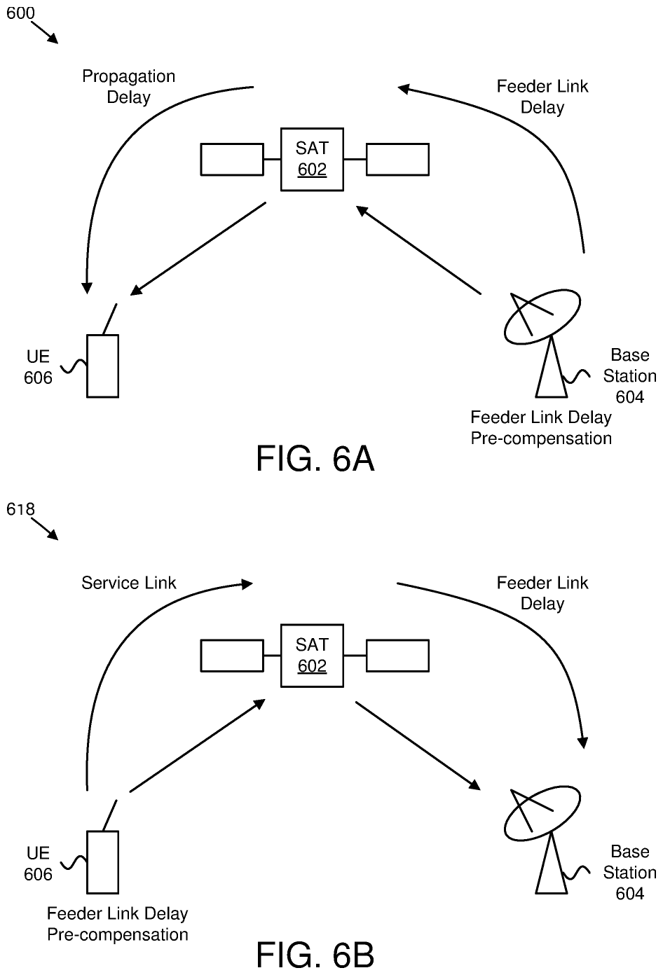

In various embodiments, in NTN there is a long round trip delay (“RTD”). The delay includes two components: a service link (e.g., between a UE and a satellite), and a feeder link (e.g., between the satellite and a base station) as shown in FIG. 6a. If the UE applies TA with full RTD, the UL and DL frame timings will be aligned at the gNB side, which is called “full TA” shown in FIG. 6b. For a UE with GNSS, the RTD of service link can be calculated with its location and satellite ephemeris. Meanwhile, the full RTD of feeder link should be signaled to the UE with the broadcast information by the gNB in the transparent payload architecture.

FIGS. 6A and 6B are schematic block diagrams illustrating embodiments of communication in systems. Specifically, FIG. 6A shows forward link communication in a system 600 including a satellite (“SAT”) 602, a base station 604, and a UE 606. Further, FIG. 6B shows return link communication in a system 618.

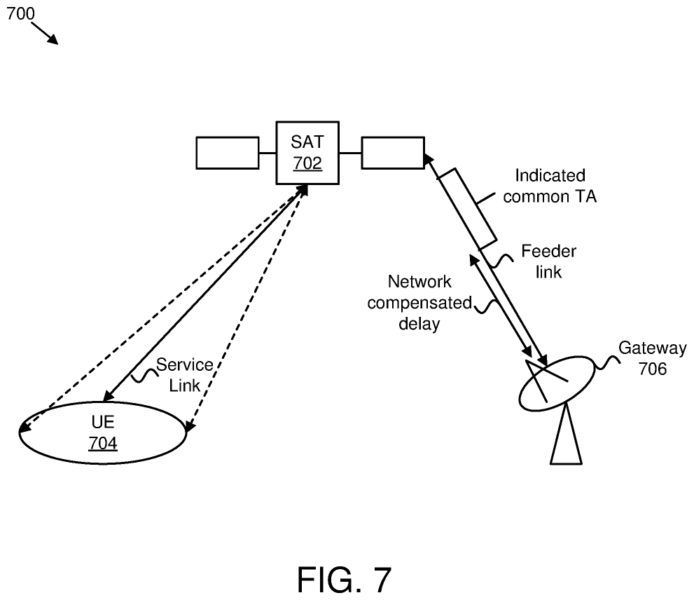

In some embodiments, a common TA parameter may be used. The common TA parameter may be provided by system information block 1 (“SIB1”). For instance, as illustrated in the FIG. 7, if a network compensates part of a feeder link propagation delay, the common TA may indicate the rest of the feeder link propagation delay (e.g., round trip) to a UE. Then, the common TA is added to the calculated service link delay, and the UE can get the feasible TA value which is applied to adjusting the uplink timing.

FIG. 7 is a schematic block diagram illustrating another embodiment of communication in a system 700. The system includes a SAT 702, a UE 704, and a gateway 706. Further, FIG. 7 illustrates a network compensated delay, a feeder link, an indicated common TA, and a service link.

In certain embodiments, for at least dynamic grants, a network may optionally configure an UL HARQ retransmission state per HARQ process. Two UL HARQ retransmission states may be defined in NTN: HARQ state A and HARQ state B.

In some embodiments, HARQ state A and HARQ state B may be defined as follows: 1) HARQ state A: length of drx-HARQ-RTT-TimerUL is extended by UE-gNB RTT (e.g., UE PDCCH monitoring is optimized to support UL retransmission grant based on UL decoding result); and 2) HARQ state B: drx-HARQ-RTT-TimerUL is not started.

In various embodiments, configuration of UL HARQ retransmission state is semi-static, signaled via RRC, and the decision and criteria to configure UL HARQ retransmission state is under network control.

In certain embodiments, for dynamic grants, each logical channel (“LCH”) may be optionally mapped to an UL HARQ retransmission state via a semi-static RRC configuration. If there is no configuration, the mapping has no effect. In some embodiments, if a HARQ process has not been configured with an UL HARQ retransmission state, a new LCH mapping rule has no effect.

In various embodiments, the following behaviors are supported for drx-HARQ-RTT-TimerUL in NTN per HARQ process: 1) timer length is extended by offset; and 2) timer disabled (e.g., not started). In certain embodiments, a UE determines drx-HARQ-RTT-TimerUL behaviour per HARQ process based on a configured UL HARQ retransmission state.

In some embodiments, for HARQ processes not configured with an UL HARQ retransmission state, drx-HARQ-RTT-TimerUL and drx-RetransmissionTimerUL behave as in legacy systems.

In various embodiments, an UL HARQ retransmission state is configured per HARQ process to support new LCH mapping restriction and proper configuration of drx-HARQ-RTT-TimerUL behavior. In certain embodiments, the network may consider delay and reliability characteristics of ongoing services when choosing to configure an UL HARQ retransmission state.

In some embodiments, a UE behavior in HARQ state A (e.g., extending the drx-HARQ-RTT-TimerUL by UE-gNB RTT) best supports reception of an UL retransmission grant based on an UL decoding result. In various embodiments, a UE behavior in HARQ state B (e.g., not starting drx-HARQ-RTT-TimerUL) best supports no UL retransmission and/or blind UL retransmission.

In certain embodiments, for HARQ state B, it may be determined to run drx-RetransmissionTimerUL for blind UL retransmission, and a UE configured with an UL HARQ retransmission state (e.g., A or B) will always act as indicated in a grant and/or assignment provided during a valid occasion (e.g., subject to legacy restrictions).

In some embodiments, there may be enhancements identified for NR NTN, such as: 1) UL HARQ protocol operation; and/or 2) logical channel prioritization procedure.

In various embodiments, there may be a HARQ retransmission state for a HARQ process (e.g., HARQ state A and/or B for dynamic grants). Such a HARQ retransmission state may describe a UE behavior with respect to a retransmission handling (e.g., blind and/or no UL retransmission or dynamically scheduled retransmissions). The network may consider delay and reliability characteristics of ongoing services when choosing to configure an UL HARQ retransmission state. For HARQ state A, UE behavior in HARQ state A best supports reception of UL retransmission grants based on UL decoding results. HARQ state B, on the contrary, best supports no UL retransmission and/or blind UL retransmission.

In certain embodiments, some enhancements are used for a PUSCH transmission scheduled by RAR during a random access procedure (e.g., msg2), which is a dynamically scheduled PUSCH transmission (e.g., in the 4-step contention based random access procedure the RAR schedules PUSCH msg3 transmission). The HARQ process used for PUSCH scheduled by RAR may be fixed in a specification (e.g., HARQ process zero is used for PUSCH transmission scheduled by RAR UL grant). This may be a RACH msg3 or for a contention-free RACH procedure, a “normal” PUSCH transmission. Since the HARQ process cannot be dynamically selected for a PUSCH transmission scheduled by RAR as for other dynamic PUSCH transmissions, a network (“NW”) has no tight control on the HARQ retransmission state applied for the data transmitted in the PUSCH and, accordingly, the corresponding UE DRX behavior. This may lead to a situation that the allocated PUSCH resources cannot be efficiently used by the UE (e.g., the configured LCH restriction may prevent the UE from using such allocated PUSCH resources or DRX behavior is not suitable for the data transmitted on the PUSCH).

In some embodiments, a HARQ retransmission state configuration (e.g., HARQ retransmission state A and/or B) is at least applicable for dynamic UL grants. For uplink configured grants, there are existing LCH restrictions (e.g., LCH can be restricted and/or mapped to CG configurations). Therefore, applying the same behavior (e.g., HARQ state configuration) as for dynamic grant also for CGs may make things complex. Basically, there may be LCH-to-CG mapping restriction and then a further LCH restriction on top may be based on the HARQ processes used by the CGs. It should be noted that HARQ processes used by a CG configuration are determined based on a formula. It may happen that different HARQ processes associated with a CG configuration are configured with different HARQ retransmission states.

In various embodiments, a NW configures HARQ process=0 always with no HARQ retransmission state to ensure that a PUSCH transmission scheduled by a RAR UL grant doesn't undergo any LCH restrictions (e.g., apart from LCH restrictions). However, such embodiments may be restrictive in terms of scheduling flexibility given that a UE may not perform a RACH procedure very often. It may mean that HARQ process=0 cannot be used by gNB according to its scheduling strategy. The HARQ process state configuration may be done for the regular dynamically scheduled PUSCH transmissions. RACH Msg3 may be bit specific since the HARQ process identifier (“ID”) used for Msg3 PUSCH is fixed even though it is a dynamically scheduled PUSCH transmission.

In certain embodiments, a UE ignores a HARQ process configuration (e.g., HARQ retransmission state configuration) configured for HARQ process=0 for a PUSCH transmission scheduled by RAR. Even though the NW may configure a HARQ process=0, i.e. HARQ process with HARQ process ID=0) with a certain HARQ retransmission state (e.g., HARQ state A or B), the UE assumes, for a PUSCH transmission scheduled by RAR UL grant (e.g., RACH Msg3), that no HARQ retransmission state is configured. This may ensure that no LCH restrictions apart from legacy LCH restrictions are applied for a PUSCH scheduled by RAR (e.g., UL grant within a random access response message). For a PUSCH scheduled by a RAR UL grant, the UE may not apply additional LCH restrictions related to a HARQ retransmission state A and/or B. Moreover, the UE may perform a logical channel prioritization (“LCP”) procedure for an UL grant received within the RAR as if no HARQ state would have been configured by the NW for HARQ process 0 (e.g., the UE performs the logical channel selection procedure during LCP with the assumption that no HARQ retransmission state is configured for a HARQ process equal to 0). As a consequence, each LCH which satisfies the other legacy conditions during a logical channel selection procedure may be mapped to a PUSCH transmission on HARQ process=0 if the PUSCH is scheduled by a RAR UL grant. According to one implementation of such embodiments, the UE behavior with respect to the drx-HARQ-RTT-TimerUL and drx-RetransmissionTimerUL may be the same as in a legacy system (e.g., the UE starts the drx-HARQ-RTT-TimerUL for the corresponding HARQ process in the first symbol after the end of the first transmission (e.g., within a bundle) of the corresponding PUSCH transmission).

In some embodiments, a UE applies a default HARQ retransmission state for a PUSCH transmission scheduled by RAR UL grant on HARQ process=0. In one example, the default HARQ state is preconfigured or fixed in a specification. According to one implementation of such embodiments, the UE ignores a HARQ process configuration (e.g., UL HARQ retransmission state per HARQ process) configured by a network and/or gNB (e.g., RRC configuration), and instead applies a default and/or preconfigured HARQ retransmission state for HARQ process=0 if the PUSCH transmission on HARQ process=0 was scheduled by a UL grant within the RAR. According to another implementation of this embodiment, the UE applies a default or preconfigured HARQ retransmission state when performing a logical channel selection procedure during an LCP and/or transport block (“TB”) generation procedure.

In various embodiments, a RAR message indicates a HARQ retransmission state for a corresponding PUSCH transmission on HARQ process=0. In one implementation of such embodiments, the RAR UL grant indicates the HARQ retransmission state for the corresponding PUSCH transmission. The HARQ retransmission state configuration signaled by the RAR overrides the HARQ process state configuration configured semi-statically by RRC signaling.

In certain embodiments, a one-bit field within a RAR UL grant is used to indicate the HARQ retransmission state for a corresponding PUSCH transmission. In one example, a one-bit field is only present for a PUSCH transmission on a non-terrestrial cell. A value 0 may indicate a HARQ retransmission state A and a value 1 may indicate a HARQ retransmission state B.

In some embodiments, a RAR UL grant schedules a PUSCH transmission from the UE. The contents of the RAR UL grant, starting with the most significant bit (“MSB”) and ending with the least significant bit (“LSB”), are given in Table 1. If the value of the frequency hopping flag is 0, the UE transmits the PUSCH without frequency hopping; otherwise, the UE transmits the PUSCH with frequency hopping. The UE determines a modulation coding scheme (“MCS”) of the PUSCH transmission from the first sixteen indexes of the applicable MCS index table for PUSCH.

In various embodiments, the TPC command value δ_{msg2,b,f,c} is used for setting the power of the PUSCH transmission. The channel state information (“CSI”) request field may be reserved. Moreover, the ChannelAccess-CPext field indicates a channel access type and cyclic prefix (“CP”) extension for operation with shared spectrum channel access if ChannelAccessMode-r16=“semistatic” is provided.

TABLE 1
Random Access Response Grant Content field size

| RAR grant field | Number of bits |
|---|---|
| Frequency hopping flag | 1 |
| PUSCH frequency resource | 14, for operation without |
| allocation | shared spectrum channel access |
| | 12, for operation with |
| | shared spectrum channel access |
| PUSCH time resource allocation | 4 |
| MCS | 4 |
| TPC command for PUSCH | 3 |
| CSI request | 1 |
| ChannelAccess-CPext | 0, for operation without |
| | shared spectrum channel access |
| | 2, for operation with |
| | shared spectrum channel access |
| HARQ retransmission state | 0, for operation in a |
| | terrestrial network |
| | 1, for operation in a |
| | non-terrestrial network |

In one example, an existing field within the RAR UL grant is reused to indicate the HARQ retransmission state for the corresponding PUSCH transmission (e.g., CSI request field or frequency hopping flag is reused for indication of the HARQ retransmission state).

In certain embodiments, a UE ignores a HARQ retransmission state configuration (e.g., HARQ state A and/or B) configured for a HARQ process when performing a LCP procedure for a PUSCH transmission on a configured uplink grant resource. According to one implementation of such embodiments, the UE only applies legacy restrictions for LCH to CG mapping and assumes that any LCH which is according to LCH restrictions and/or configurations allowed to use a configured grant may be considered for TB generation—during logical channel selection procedure—even though the corresponding HARQ process may be configured with a HARQ retransmission state. It should be noted that a LCH may be configured to use a dynamic PUSCH resource as well as a configured uplink grant resource. According to such embodiments, a LCH configuration where a LCH is mapped to an UL HARQ retransmission state via semi-static RRC configuration may be only applied for dynamically scheduled PUSCH transmissions and ignored by the UE for CG PUSCH transmissions.

In some embodiments, a UE applies a defined DRX related timer handling according to a HARQ retransmission state configuration for a CG PUSCH transmission; however, the UE ignores the LCH restriction (e.g., LCH to CG restriction configuration is used to determine which LCHs may be transmitted on the CG PUSCH). Any LCH to HARQ retransmission state mapping configuration may be ignored for a PUSCH transmission on an UL configured grant and only the DRX related timer handling associated with a HARQ retransmission state is applied for CG PUSCH transmissions (e.g., drx-HARQ-RTT-TimerUL may not be started for a CG PUSCH transmission on a HARQ process which is configured with HARQ retransmission state B).

According to one implementation of such embodiments, the UE applies the HARQ retransmission (“ReTx”) state for HARQ retransmissions of CG PUSCH transmission (e.g., initial transmission was done on a configured uplink grant resource). Since retransmission of CG PUSCH transmission are dynamically scheduled by the gNB, the UE applies the DRX behavior according to the HARQ ReTx state configured for the HARQ process. This means that the UE applies the defined DRX timer handling behavior (eg., drx-RetransmissionTimerUL and drx-HARQ-RTT-TimerUL) according to the HARQ ReTx state configured for the HARQ process for HARQ retransmissions when the initial transmission was a CG PUSCH transmission.

In various embodiments, an uplink configured grant configuration is configured with a HARQ process configuration, e.g. HARQ retransmission state. The NW may configure a HARQ retransmission state for a configured grant when configuring the configured grant configuration (e.g., NW associates a HARQ retransmission state with the uplink configured grant resources). According to such embodiments, the UE applies the HARQ retransmission state (e.g., HARQ state A and/or B) for each HARQ process which is used for uplink transmissions associated with the configured grant configuration. It should be noted that HARQ processes associated with an UL CG are determined based on a formula which considers the transmission timing (e.g., slot and/or frame number). Accordingly, the UE knows what behavior to support for the CG transmissions (e.g., reception of UL retransmission grant based on UL decoding results or blind repetitions). According to one aspect of such embodiments, the UE doesn't start and/or apply a CGRetransmissionTimer if a CG is configured with a HARQ retransmission state B (e.g., blind HARQ retransmission mode).

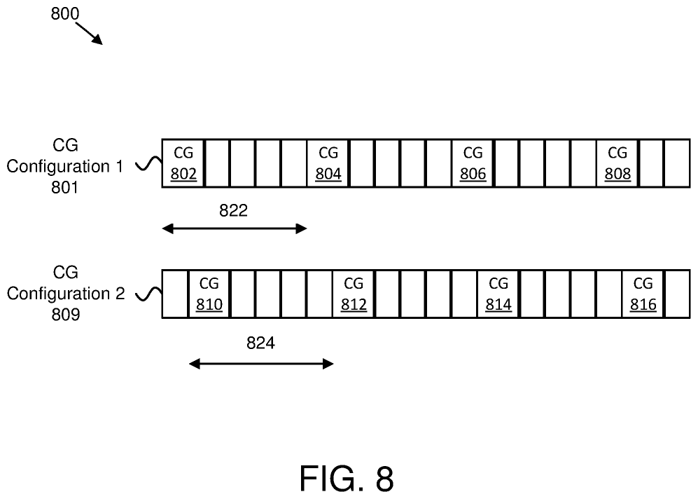

FIG. 8 is a schematic block diagram illustrating one embodiment of communications 800 corresponding to CG configurations. The communications 800 include a CG configuration 1 801 having a first CG (HARQ process=0, HARQ ReTx state=B) 802, a second CG (HARQ process=1, HARQ ReTx state=B) 804, a third CG (HARQ process=0, HARQ ReTx state=B) 806, and a fourth CG (HARQ process=1, HARQ ReTx state=B) 808. Moreover, the communications 800 include a CG configuration 2 809 having a first CG (HARQ process=2, HARQ ReTx state=A) 810, a second CG (HARQ process=2, HARQ ReTx state=A) 812, a third CG (HARQ process=2, HARQ ReTx state=A) 814, and a fourth CG (HARQ process=2, HARQ ReTx state=A) 816. A first periodicity 822 corresponds to the CG configuration 1 801, and a second periodicity 824 corresponds to the CG configuration 2 809.

As illustrated, the CG configuration 1 801 is associated with 2 HARQ processes (e.g., HARQ_ID=0,1), whereas the CG configuration 2 809 is associated with a single HARQ process (e.g., HARQ_ID=2). The NW configured HARQ retransmission state=B for the CG configuration 1 801 means that the UE applies HARQ retransmission state=B for the LCP procedure and/or DRX behavior when performing a CG PUSCH transmissions on HARQ process=0,1. Accordingly, the UE applies HARQ ReTx state=A when performing a CG uplink shared channel transmission (“CG-PUSCH”) on HARQ process=2 (e.g., according to the CG configuration 2 809).

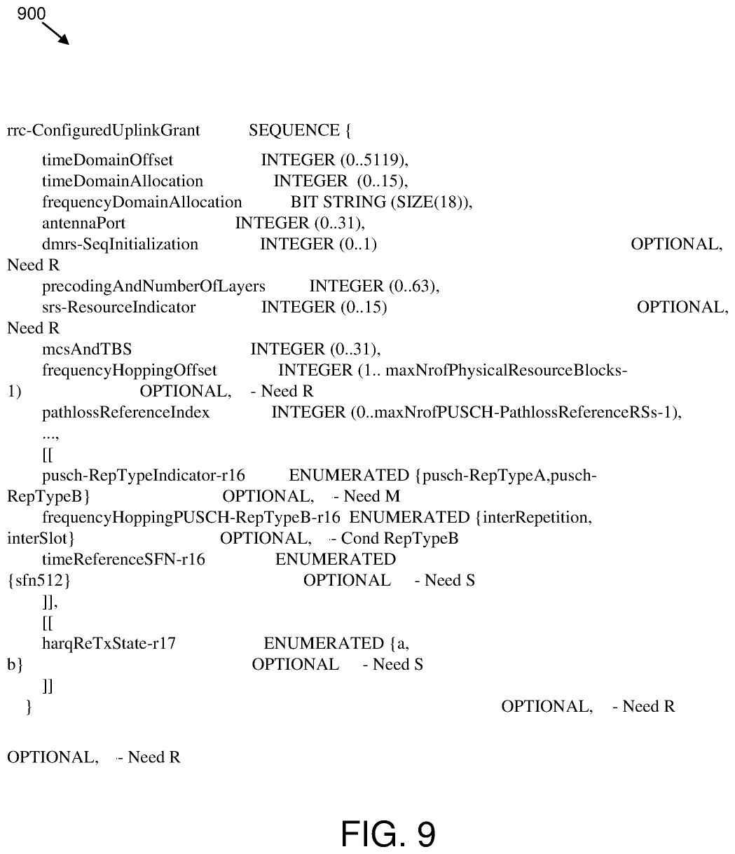

In one embodiment, a new field may be added to a field rrc-ConfiguredUplinkGrant in IE ConfiguredGrantConfig—used to configure uplink transmissions without dynamic grant—indicating which HARQ retransmission state is applied for uplink transmission according to the configured grant configuration. In the example of FIG. 9, the field harqRetxState indicates the HARQ retransmission state the UE shall apply for uplink transmissions on the configured grant resources. If the field is not present, the UE does not apply a HARQ retransmission state to the HARQ processes associated with the configured grant configuration. Specifically, FIG. 9 is a diagram illustrating one embodiment of a configured grant IE 900.

In certain embodiments, a UE only applies a DRX timer related behavior according to a HARQ process configuration for UL CG (e.g., drx-HARQ-RTT-TimerUL may not be started for a CG PUSCH transmission on a HARQ process which is configured with HARQ retransmission state B), and does not apply any LCH to HARQ retransmission state mapping restriction for CG PUSCH transmissions. During the Logical channel selection procedure, the UE ignores any configured LCH to HARQ retransmission state mapping configuration and applies the legacy LCH to CG mapping configuration.

In some embodiments, a UE considers a HARQ process as not pending if the HARQ process is configured with a preconfigured and/or predefined HARQ retransmission state. According to an implementation of such embodiments, the UE considers a HARQ process as not pending—even if listen before talk (“LBT”) fails for an UL transmission on that HARQ process—if the corresponding HARQ process is configured with a predefined HARQ retransmission state. In one example, the predefined HARQ retransmission state is a HARQ retransmission state, where the NW schedules blind HARQ retransmissions (e.g., the NW schedules UL retransmissions not based on UL decoding results). Such embodiments assume that the HARQ retransmission state configuration is applied for operation in a shared spectrum (e.g., the cell operates in an unlicensed spectrum). In one implementation of such embodiments, a cg-RetransmissonTimer is configured for a MAC and/or UE.

In various embodiments, a HARQ process cannot be pending for cases when the HARQ process is configured with a HARQ retransmission state. In one implementation of such embodiments, a cg-RetransmissonTimer is configured for a MAC and/or UE. Even if LBT failure occurs and/or is indicated from a lower layer for a PUSCH transmission on a HARQ process which is configured with a HARQ retransmission state (e.g., HARQ retransmission state A or B), the corresponding HARQ process is considered as not pending. Only HARQ processes which are not configured with a HARQ retransmission state can be pending (e.g., if LBT failure occurs for a PUSCH transmission on that HARQ process).

In certain embodiments, an UL grant being associated with a HARQ process which is configured with a predefined HARQ retransmission state is always considered as a prioritized UL grant. In such embodiments, lch-basedPrioritization is configured for a UE and/or MAC. Since the priority status of the UL grant cannot be changed to “deprioritized”—even for cases when the UL grant is preempted and/or deprioritized by a higher priority overlapping uplink grant and/or uplink transmission—the UE and/or MAC will not perform autonomous transmissions specified via industrial internet of things (“I-IoT”) functionality. In one example, the predefined HARQ retransmission state is a HARQ retransmission state, where the NW schedules UL retransmissions based on UL decoding results.

In some embodiments, a UE considers a HARQ retransmission state configured for a UL HARQ process when performing HARQ process selection. In one implementation of such embodiments, the UE prioritizes HARQ processes which are configured with a predefined HARQ retransmission state when performing HARQ process selection. In some implementations, HARQ processes with a pending HARQ retransmissions may be prioritized over HARQ processes used for an initial new transmission. Furthermore, a NW may configure that HARQ process selection takes priority of a data and/or UL grant associated with a HARQ process into account when selecting a HARQ process for a CG PUSCH transmission. In one example, the predefined HARQ retransmission state is a HARQ retransmission state, where the NW schedules UL retransmissions based on UL decoding results.

In various embodiments, a UE considers an UL grant which is associated with a HARQ process being configured with a predefined HARQ retransmission state as a prioritized UL grant if the UL grant overlaps with another uplink grant and/or uplink transmission regardless of the priority of the data transmitted (e.g., retransmission case) or to be transmitted (e.g., new initial transmission) in the overlapping UL grants. In some implementations, the priority of an uplink transmission may be determined by the highest priority among priorities of the logical channels with data available that are multiplexed (e.g., retransmission case) or can be multiplexed in the MAC protocol data unit (“PDU”) (e.g., for new transmission) according to mapping restrictions. According to one implementation, the UE prioritizes UL transmission on a HARQ process configured with a HARQ retransmission state (e.g., state A or state B). The motivation for this new prioritization rule may be to ensure that the NW and/or gNB is aware of the UE behavior with respect to the DRX timer handling (e.g., gNB needs to be aware of whether the UE starts the drx-HARQ-RTT-TimerUL, or not, and which value the UE applies for the drx-HARQ-RTT-TimerUL timer).

In certain embodiments, a network configures a LCH to beam mapping configuration which a UE applies when performing a LCP procedure for an UL transmission. Especially at higher carrier frequencies, multiple beams may operate nominally on the same cell where the spatial characteristic of each beam can ensure that there is little correlation of the channel characteristics, thereby enabling another degree of diversity. It is therefore possible that the cell restriction functionality (e.g., in the context of carrier aggregation (“CA”) and/or dual connectivity (“DC”) duplication), does not need to be upheld. For example, duplicated packets may be transmitted on the same cell with different beams. According to one implementation, a LCH may be configured with a set of spatial relation information (e.g., representing a beam, for example, using a TCI index and/or SRI index). When receiving an UL grant allocating PUSCH resources for a new initial transmission, the UE maps a LCH to the UL grant resource if the set of spatial relation information configured for a LCH includes the spatial relation information signaled within the UL grant. By using such new LCH to spatial relation information mapping configuration, the NW may ensure that packets of a duplication bearer are sent on the same cell with different beams. In one example, the beams may be associated with different transmission and reception points (“TRPs”) (e.g., the new LCH mapping configuration ensures that duplicated packets are transmitted to different TRPs). In one embodiment, a LCH may be mapped to a set of search spaces or control resource sets (“CORESETs”) (e.g., RRC additionally controls the LCP procedure by configuring a new mapping restriction for each logical channel (e.g., RRC configures the allowed search spaces and/or CORESETs for transmission)). When performing an LCP procedure for an initial UL and/or PUSCH transmission, the UE is only allowed to multiplex data of LCHs which have the search space and/or CORESET on which the corresponding UL grant and/or DL control information (“DCI”) was received in their configured allowed set of search spaces and/or CORESETs. According to one implementation, the UE, by the virtue of LCH to beam mapping, ensures that PDCP duplicates are not being transmitted using the same beams. To use the benefit of spatial diversity, the UE applies some predefined rules and/or behaviors for the LCH to beam and/or spatial relation mapping for the transmission of data of a duplication bearer. If a PDCP PDU was transmitted on a certain beam (e.g., beam X), the UE ensures that the duplicate of such PDCP PDU (e.g., using a different LCH) is transmitted on a different beam Y having little correlation of the channel characteristics with beam X.

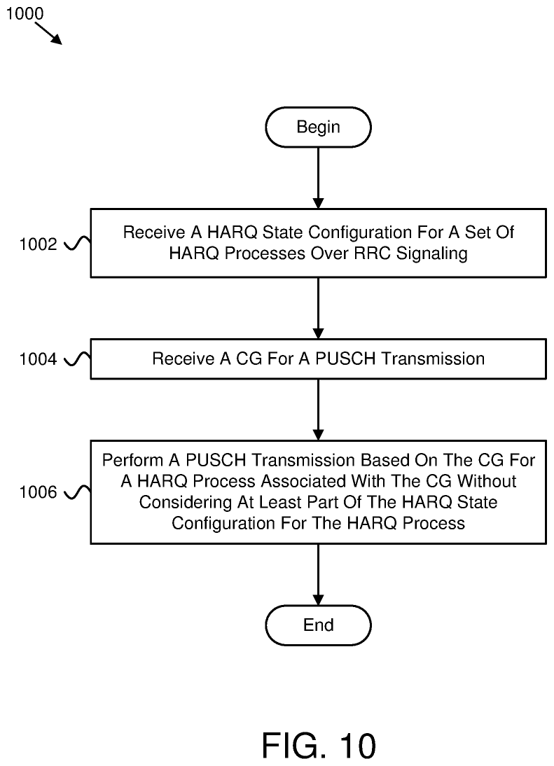

FIG. 10 is a flow chart diagram illustrating one embodiment of a method 1000 for performing a physical uplink shared channel transmission based on a configured grant. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002 a HARQ state configuration for a set of HARQ processes over RRC signaling. In some embodiments, the method 1000 includes receiving 1004 a CG for a PUSCH transmission. In certain embodiments, the method 1000 includes performing 1006 a PUSCH transmission based on the CG for a HARQ process associated with the CG without considering at least part of the HARQ state configuration for the HARQ process.

In certain embodiments, the method 1000 further comprises applying no HARQ state for the PUSCH transmission. In some embodiments, the method 1000 further comprises applying a default HARQ state for the PUSCH transmission. In various embodiments, the method 1000 further comprises receiving a CG HARQ state configuration corresponding to the CG.

In one embodiment, the method 1000 further comprises configuring the PUSCH transmission based on the CG HARQ state configuration. In certain embodiments, the CG HARQ state configuration is received over RRC signaling. In some embodiments, the method 1000 further comprises not starting a DRX timer in response to performing the PUSCH transmission based on the CG.

In various embodiments, the DRX timer is a drx-HARQ RTTtimerUL. In one embodiment, performing the PUSCH transmission based on the CG for the HARQ process associated with the CG without considering at least part of the HARQ state configuration for the HARQ process comprises performing the PUSCH transmission based on the CG without considering the entire HARQ state configuration.

In certain embodiments, performing the PUSCH transmission based on the CG for the HARQ process associated with the CG without considering at least part of the HARQ state configuration for the HARQ process comprises performing the PUSCH transmission based on the CG without considering an LCP restriction of the HARQ state configuration. In some embodiments, the method 1000 further comprises applying a DRX timer of the HARQ state configuration to the PUSCH transmission.

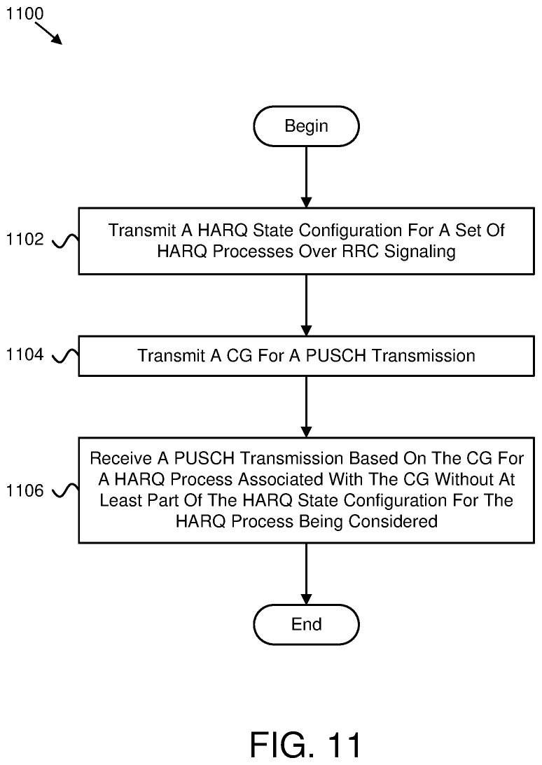

FIG. 11 is a flow chart diagram illustrating another embodiment of a method 1100 for performing a physical uplink shared channel transmission based on a configured grant. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes transmitting 1102 a HARQ state configuration for a set of HARQ processes over RRC signaling. In some embodiments, the method 1100 includes transmitting 1104 a CG for a PUSCH transmission. In certain embodiments, the method 1100 includes receiving 1106 a PUSCH transmission based on the CG for a HARQ process associated with the CG without at least part of the HARQ state configuration for the HARQ process being considered.

In certain embodiments, the method 1100 further comprises transmitting a CG HARQ state configuration corresponding to the CG.

In one embodiment, an apparatus comprises: a receiver to: receive a HARQ state configuration for a set of HARQ processes over RRC signaling; and receive a CG for a PUSCH transmission; and a transmitter to perform a PUSCH transmission based on the CG for a HARQ process associated with the CG without considering at least part of the HARQ state configuration for the HARQ process.

In certain embodiments, the apparatus further comprises a processor to apply no HARQ state for the PUSCH transmission.

In some embodiments, the apparatus further comprises a processor to apply a default HARQ state for the PUSCH transmission.

In various embodiments, the receiver further to receive a CG HARQ state configuration corresponding to the CG.

In one embodiment, the apparatus further comprises a processor to configure the PUSCH transmission based on the CG HARQ state configuration.

In certain embodiments, the CG HARQ state configuration is received over RRC signaling.

In some embodiments, the apparatus further comprises a processor to not start a DRX timer in response to performing the PUSCH transmission based on the CG.

In various embodiments, the DRX timer is a drx-HARQ RTTtimerUL.

In one embodiment, the transmitter to perform the PUSCH transmission based on the CG for the HARQ process associated with the CG without considering at least part of the HARQ state configuration for the HARQ process comprises the transmitter to perform the PUSCH transmission based on the CG without considering the entire HARQ state configuration.

In certain embodiments, the transmitter to perform the PUSCH transmission based on the CG for the HARQ process associated with the CG without considering at least part of the HARQ state configuration for the HARQ process comprises the transmitter to perform the PUSCH transmission based on the CG without considering an LCP restriction of the HARQ state configuration.

In some embodiments, the apparatus further comprises a processor to apply a DRX timer of the HARQ state configuration to the PUSCH transmission.

In one embodiment, a method at a UE, the method comprises: receiving a HARQ state configuration for a set of HARQ processes over RRC signaling; receiving a CG for a PUSCH transmission; and performing a PUSCH transmission based on the CG for a HARQ process associated with the CG without considering at least part of the HARQ state configuration for the HARQ process.

In certain embodiments, the method further comprises applying no HARQ state for the PUSCH transmission.

In some embodiments, the method further comprises applying a default HARQ state for the PUSCH transmission.

In various embodiments, the method further comprises receiving a CG HARQ state configuration corresponding to the CG.

In one embodiment, the method further comprises configuring the PUSCH transmission based on the CG HARQ state configuration.

In certain embodiments, the CG HARQ state configuration is received over RRC signaling.

In some embodiments, the method further comprises not starting a DRX timer in response to performing the PUSCH transmission based on the CG.

In various embodiments, the DRX timer is a drx-HARQ RTTtimerUL.

In one embodiment, performing the PUSCH transmission based on the CG for the HARQ process associated with the CG without considering at least part of the HARQ state configuration for the HARQ process comprises performing the PUSCH transmission based on the CG without considering the entire HARQ state configuration.

In certain embodiments, performing the PUSCH transmission based on the CG for the HARQ process associated with the CG without considering at least part of the HARQ state configuration for the HARQ process comprises performing the PUSCH transmission based on the CG without considering an LCP restriction of the HARQ state configuration.

In some embodiments, the method further comprises applying a DRX timer of the HARQ state configuration to the PUSCH transmission.

In one embodiment, an apparatus comprises: a transmitter to: transmit a HARQ state configuration for a set of HARQ processes over RRC signaling; and transmit a CG for a PUSCH transmission; and a receiver to receive a PUSCH transmission based on the CG for a HARQ process associated with the CG without at least part of the HARQ state configuration for the HARQ process being considered.

In certain embodiments, the transmitter further to transmit a CG HARQ state configuration corresponding to the CG.

In one embodiment, a method at a network device, the method comprises: transmitting a HARQ state configuration for a set of HARQ processes over RRC signaling; transmitting a CG for a PUSCH transmission; and receiving a PUSCH transmission based on the CG for a HARQ process associated with the CG without at least part of the HARQ state configuration for the HARQ process being considered.

In certain embodiments, the method further comprises transmitting a CG HARQ state configuration corresponding to the CG.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a hybrid automatic repeat request (HARQ) state configuration for a set of HARQ processes over radio resource control (RRC) signaling;
receive a configured grant (CG) for a physical uplink shared channel (PUSCH) transmission; and
perform a PUSCH transmission based on the CG for a HARQ process associated with the CG without considering at least part of the HARQ state configuration for the HARQ process.

2. The UE of claim 1, wherein the at least one processor is configured to cause the UE to apply no HARQ state for the PUSCH transmission.

3. The UE of claim 1, wherein the at least one processor is configured to cause the UE to apply a default HARQ state for the PUSCH transmission.

4. The UE of claim 1, wherein the at least one processor is configured to cause the UE to receive a CG HARQ state configuration corresponding to the CG.

5. The UE of claim 4, wherein the at least one processor is configured to cause the UE to configure the PUSCH transmission based on the CG HARQ state configuration.

6. The UE of claim 4, wherein the CG HARQ state configuration is received over RRC signaling.

7. The UE of claim 4, wherein the at least one processor is configured to cause the UE to not start a discontinuous reception (DRX) timer in response to performing the PUSCH transmission based on the CG.

8. The UE of claim 7, wherein the DRX timer is a drx-HARQ RTTtimerUL.

9. The UE of claim 1, wherein the at least one processor is configured to cause the UE CG for the HARQ process associated with the CG without considering at least part of the to perform the PUSCH transmission based on the CG without considering the entire HARQ state configuration.

10. The UE of claim 1, wherein the at least one processor is configured to cause the UE to perform the PUSCH transmission based on the CG without considering an LCP restriction of the HARQ state configuration.

11. The UE of claim 8, wherein the at least one processor is configured to cause the UE to apply a DRX timer of the HARQ state configuration to the PUSCH transmission.

12. A method performed by a user equipment (UE), the method comprising:
receiving a hybrid automatic repeat request (HARQ) state configuration for a set of HARQ processes over radio resource control (RRC) signaling;
receiving a configured grant (CG) for a physical uplink shared channel (PUSCH) transmission; and
performing a PUSCH transmission based on the CG for a HARQ process associated with the CG without considering at least part of the HARQ state configuration for the HARQ process.

13. The method of claim 12, further comprising applying no HARQ state for the PUSCH transmission.

14. A base station, comprising:
at least one memory; and
at least one processor coupled with the at least one memory and configured to cause the base station to:
transmit a hybrid automatic repeat request (HARQ) state configuration for a set of HARQ processes over radio resource control (RRC) signaling;
transmit a configured grant (CG) for a physical uplink shared channel (PUSCH) transmission; and
receive a PUSCH transmission based on the CG for a HARQ process associated with the CG without at least part of the HARQ state configuration for the HARQ process being considered.

15. The method of claim 14, wherein the at least one processor is configured to cause the apparatus to transmit a CG HARQ state configuration corresponding to the CG.

16. A user equipment (UE), comprising:
at least one memory; and
at least one processor coupled with the at least one memory and configured to cause the UE to:
receive a configured grant (CG) configuration for a physical uplink shared channel (PUSCH) transmission, wherein the CG configuration indicates whether a timer is to be started for a PUSCH transmission; and
perform the PUSCH transmission based on the CG configuration for the PUSCH transmission.

17. The UE of claim 16, wherein the timer comprises a drx-HARQ-RTT-TimerUL.

18. The UE of claim 16, wherein the CG configuration indicates whether the timer is to be started for the PUSCH transmission using a field in the CG configuration.
